(19) United States
(12) Patent Application Publication
(10) Pub. No.: US 2013/0103508 A1
(43) Pub. Date: Apr. 25, 2013

(54) System and method for goods and services promotion

(71) Applicant: Mikhail Leonidovich Liubachev, Saint-Petersburg (RU)

(72) Inventor: Mikhail Leonidovich Liubachev, Saint-Petersburg (RU)

(21) Appl. No.: 13/680,123

(22) Filed: Nov. 19, 2012

Related U.S. Application Data
(60) Provisional application No. 61/697,311, filed on Sep. 6, 2012.

(51) Int. Cl. G06Q 30/02

(52) U.S. Cl. CPC G06Q 30/0277
USPC 705/14.73

(57) ABSTRACT

A computer implemented method for goods and/or services promotion, comprising: preliminarily creating a plurality of promo-campaigns; distributing the one or more of the preliminarily created promo-campaigns to a first computer system; sending one or more messages, associated with the promo-campaign, from the first computer system to the second computer system; receiving, at the second computer system the one or more messages from the first computer system; analyzing the received one or more messages contents.

### FIELD OF INVENTION

This invention relates to the systems and methods of goods and services promotion using electronic devices and computer systems.

### RELATED ART

In recent years, there has been a dramatic increase in the functional capabilities of Internet services. Current online services provide a platform for companies to post their advertisements and manage customers who apply to participate in them. Online advertisements, such as discount promo-campaigns, have proven to be quite popular.

However, the functionality of such online web-resources is limited to posting a description of the offer and then collecting information about participants. There are two scenarios in this setting. One is when customers from the same city as the company that posted the online advertisement purchase or agree to use a special offer or discount. To participate in a promo-campaign or to use a special offer, the customer needs to print a purchased coupon or write down a coupon code. Once the customer has a hard copy of the coupon, he or she needs to call the company that posted the online advertisement, and book goods or services, typically 24 hours in advance. In the second scenario, the customer may be located in another city from the company which posted the online advertisement. As a result, in order to use a special offer or discount, the customer will need:
to plan his day beforehand;
to book goods or services 24 hours in advance of purchase;
to travel to the company which posted the online advertisement.

Additionally, the customer may have a change of plan at the last minute and not be able to avail of the special offer from the company which posted the online advertisement. Another factor is the duration of the promo-campaign or online advertisement, which could vary from one day to several months. If the duration is small, many customers may not be able to buy the advertised goods or services from the company.

Another limitation of the current online advertisement platforms is that they cannot provide special offers interactively and fast to customers located near the company. A customer can't purchase a coupon and use it immediately even if he or she is right inside the company that ran the online advertisement. In order to buy and use a coupon, the customer needs to leave the company's premises, purchase a coupon, print it and book goods and services. Only after these steps, the customer is be able to buy the goods and services advertised in the special offer.

The present invention solves above-mentioned problems and offers both companies and customers a platform for goods and services promotion.

### SUMMARY OF THE INVENTION

In accordance with some embodiments, a computer implemented method for goods and/or services promotion, comprising: preliminarily creating a plurality of promo-campaigns, containing information about one or more goods and/or services; distributing the one or more of the preliminarily created promo-campaigns to a first computer system; sending one or more messages, associated with the promo-campaign, from the first computer system to the second computer system; receiving, at the second computer system the one or more messages from the first computer system; analyzing the received one or more messages contents; if, after the analysis, the user of the second computer system reveals or the second computer system identifies, by means of implemented algorithm, that the user of the first computer system requested one or more goods and/or services, the second computer system, by means of the implemented algorithm, or the user of the second computer system performs the following steps: assigning a newly generated or a preliminarily created identifier, which identifies the first computer system or the one or more user of the first computer system in the promo campaign or in the second computer system; sending the identifier, obtained on the previous step to the first computer system; if, after the analysis, the user of the second computer system reveals or the second computer system identifies, by means of implemented algorithm, that the user of the first computer system requested additional details about promo-campaign, the user of the second computer system or the second computer system, by means of the implemented algorithm, performs the following steps: creating one or more messages with information requested by the user of the first computer system-or assigning preliminarily created one or more messages, which comprises information about promo campaign terms and conditions or description; sending one or more messages, obtained on the previous step, to the first computer system.

In accordance with some embodiments of the present invention, a computer implemented method for goods and services promotion, comprising: preliminarily creating, by one or more users of a second computer system, a promo-campaign, which contains information about one or more goods and/or services; distributing the created promo-campaign to at least two computer systems from the first computer system group, wherein the first computer system group comprises at least two computer systems; creating a group of two or more computer systems by the first computer system from the first computer system group via sending one or more requests to join group to other users of the computer systems from the first computer system group; sending one or more messages, associated with the promo-campaign, from at least one computer system from the group, created on the step c. and group identifier, that the one or more messages were sent from one or more computer systems from the group, created on the step c.; receiving, at the second computer system, the one or more messages, sent on the previous step; analyzing the received one or more messages content; if, after the analysis, the user of the second computer system reveals or the second computer system identifies by means of implemented algorithm, that at least one user of the computer system from the first computer system group requested one or more goods and/or services, the second computer system by means of the implemented algorithm or the user of the second computer system performs the following steps: generating a new identifier or assigning previously created identifier; sending the identifier, obtained on the previous step to the computer system from the first computer system group, user of which requested one or more goods and/or services or to all computer systems from the first computer system group; if, after the analysis, the user of the second computer system reveals or the second computer system, by means of implemented algorithm, identifies that at least one user of the computer system from the first computer system group requested additional information about promo-campaign description/contents, the user of the second computer system or the second computer system, by means of the implemented algorithm, performs the following steps: creating, one or more messages with information requested by the user of the computer system from the first computer system group or assigning preliminarily created one or more messages, which comprises information about promo campaign terms and conditions or description; sending one or more messages, obtained on the previous step, to the computer system from the first computer system group, user of which requested additional information.

In accordance with embodiments, a computer implemented method for goods and/or services promotion, comprising: sending, by the one or more users of the first computer system, one or more messages to the second computer system, notifying the one or more users of the second computer system, that the one or more users of the first computer system are interested in one or more goods and/or services; receiving, at the second computer system the one or more messages from the first computer system; analyzing the received one or more messages contents; if, after the analysis, the user of the second computer system reveals or the second computer system identifies, by means of implemented algorithm, that the user of the first computer system requested one or more goods and/or services, the second computer system, by means of the implemented algorithm, or the user of the second computer system performs the following steps: assigning a newly generated or a preliminarily created identifier, which identifies the first computer system or the one or more user of the first computer system in the promo campaign; sending the identifier, obtained on the previous step to the first computer system; if, after the analysis, the user of the second computer system reveals or the second computer system identifies, by means of implemented algorithm, that the user of the first computer system requested additional details about promo-campaign, the user of the second computer system or the second computer system, by means of the implemented algorithm, performs the following steps: creating one or more messages with information requested by the user of the first computer system or assigning preliminarily created one or more messages, which comprises information about promo campaign terms and conditions or description; sending one or more messages, obtained on the previous step, to the first computer system.

In accordance with some embodiments of the present invention, system for goods and services promotion, comprising: first computer system; a second computer system; wherein the second computer system comprises: one or more processors #2; one or more devices for storing data #2; one or more communication modules #2; one or more programs #2; wherein the one or more programs #2 are stored in the one or more devices for storing data #2 and configured to be executed by the one or more processors #2, the one or more programs #2 containing instructions for: creating a promo-campaign, which contains information about one or more goods and/or services; distributing, by means of the one or more communication modules #2 the created promo-campaign to other one or more computer systems; receiving, by means of the one or more communication modules #2, the one or more messages from other one or more computer systems; analyzing the received one or more messages contents; receiving the identifier, by means of the one or more communication modules #2, from the first computer system or intermediate computer system; wherein the first computer system comprises: one or more processors #1; one or more devices for storing data #1; one or more communication modules #1; one or more programs #1; wherein the one or more programs #1 are stored in the one or more devices for storing data #1 and configured to be executed by the one or more processors #1, the one or more programs #1 containing instructions for: receiving the promo-campaign, by means of the one or more communication modules #1, from other one or more computer systems; sending one or more messages, regarding promo campaign, by means of the one or more communication modules #1 to the one or more computer systems, associated with the promo campaign; generating a new identifier or assigning previously created identifier to the first computer system.

### BRIEF DESCRIPTION OF THE DRAWINGS

For a better understanding of the aforementioned embodiments of the invention as well as additional embodiments thereof, reference should be made to the detailed description below, in conjunction with the following drawings in which like reference numerals refer to corresponding parts throughout the figures.

FIG. 1 and FIG. 2 illustrates first and second computer systems according to the preferred embodiment.

FIG. 3 is a block diagram illustrating method of goods and services promotion in accordance with some embodiments of the present invention.

FIG. 4 illustrates examples of the objects of the information in accordance with some embodiments of the present invention.

FIG. 5 shows the graphical user interface with the information about the user according to some embodiments of the present invention.

FIG. 6 shows the updated graphical user interface with the information about the user according to some embodiments of the present invention.

FIG. 7 shows the update process according to some embodiments of the present invention.

FIG. 8 illustrates a graphical user interface, which is shown to the user of the device according to some embodiments of the present invention.

FIG. 9 shows the example of the modified graphical user interface according to some embodiments of the present invention.

FIG. 10 and FIG. 11 show the examples of the modified graphical user interface according to some embodiments of the present invention.

FIG. 12 illustrates a graphical user interface with the table with information about the user, after the first computer system sends the message to the second computer system, according to some embodiments of the present invention.

FIG. 13 illustrates one of the methods of interaction between computer systems, according to some embodiments of the present invention.

FIG. 14 illustrates a graphical user interface, shown on the first computer system, according to some embodiments.

FIG. 15 shows the graphical user interface for promo-campaign creation according to some embodiments of the present invention.

FIG. 16 shows the graphical user interface with promo-campaign according to some embodiments of the present invention.

FIG. 17 and FIG. 18 show the graphical user interfaces with parts of the promo-campaign content according to some embodiments of the present invention.

FIG. 19 shows the modified graphical user interface, which comprises promo-campaigns and discussion functionality according to some embodiments of the present invention.

FIG. 20 and FIG. 21 shows the conversation functionality according to some embodiments of the present invention.

FIG. 22 and FIG. 23 shows the systems that can be used in the hotel and by users who want to make room reservations or booking according to some embodiments of the present invention.

FIG. 24A and FIG. 24B show the parts of the graphical user interface that can be used in the hotel while utilizing the present invention according to some embodiments of the invention.

### DETAILED DESCRIPTION

Reference will now be made in detail to the embodiments, examples of which are illustrated in the accompanying drawings. In this detailed description, numerous specific details are set forth in order to provide a thorough understanding of the present invention. However, it will be apparent to a person of ordinary skills in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the system and methods for goods and services promotion are described. For purposes of explanation of the preferred embodiment, it will be assumed that:
the first computer system will take the form of a personal computer;
the second computer system will take the form of a smartphone, for example, those which utilize iOS, Android or Windows Mobile operating systems.
   It should be clearly understood that the present invention should not be limited to use in the above described first and second computer systems.

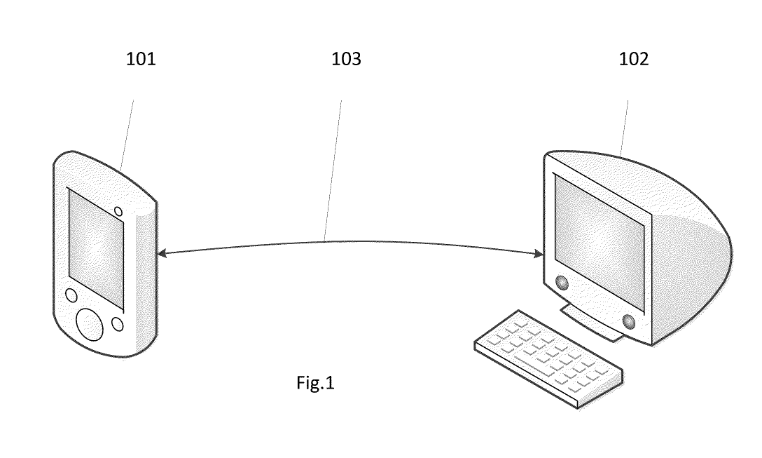

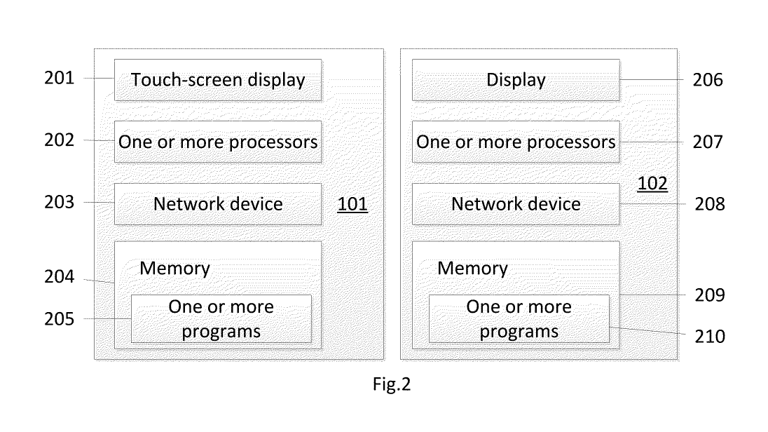

FIG. 1 and FIG. 2 illustrate the first and second computer systems according to the preferred embodiment. The first computer system is represented by the smartphone 101, which comprises the following elements:
a touch-screen display 201,
one or more processors 202,
a network device 203, suitable for sending and receiving objects of the information to one or more computer systems,
a memory 204 and
one or programs 205, stored in the memory 204.

It should be appreciated that the device 101 is only one example of a first computer system, and that the device 101 may have more or fewer components than shown, may combine two or more components, or a may have a different configuration or arrangement of the components. The various components shown in FIG. 2 may be implemented in hardware, software or a combination of hardware and software, including one or more signal processing and/or application specific integrated circuits.

The smartphone 101 supports a variety of applications, such as a telephone application, a video conferencing application, an e-mail application, an instant messaging application, a blogging application, a digital camera application, a digital video camera application, a web browsing application, a digital music player application, and/or a digital video player application.

The touch-sensitive touch screen 201 provides an input interface and an output interface between the device 101 and a user. The display controller (not shown) receives and/or sends electrical signals from/to the touch-screen 201. The touch-screen 201 displays visual output to the user. The visual output may include graphics, text, icons, video, and any combination thereof (collectively termed “graphics”). In some embodiments, some or all of the visual output may correspond to user-interface objects.

The touch-screen 201 has a touch-sensitive surface, sensor or set of sensors that accepts input from the user based on haptic and/or tactile contact. The touch-screen 201 and the display controller (along with any associated modules and/or sets of instructions in memory 204) detect contact (and any movement or breaking of the contact) on the touch-screen 201 and convert the detected contact into interaction with user-interface objects (e.g., one or more soft keys, icons, web pages or images) that are displayed on the touch-screen.

The various applications that may be executed on the smartphone 101 may use at least one common physical user-interface device, such as the touch-screen 201. One or more functions of the touch-screen 201 as well as corresponding information displayed on the smartphone 101 may be adjusted and/or varied from one application to the next and/or within a respective application. In this way, a common physical architecture (such as the touch-screen 201) of the device may support the variety of applications with user interfaces that are intuitive and transparent.

The one or more processors 202 run or execute various software programs and/or sets of instructions stored in memory 204 to perform various functions for the smartphone 101 and to process data.

The one or more processors 207 run or execute various software programs and/or sets of instructions stored in memory 209 to perform various functions for the personal computer 102 and to process data.

The network device 203 and 208 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), High-speed Downlink Packet Access (HSDPA), Wideband Code Division Multiple Access (W-CDMA), Code Division Multiple Access (CDMA), Time Division Multiple Access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail, such as Internet message access protocol (IMAP) and/or post office protocol (POP), instant messaging, for example, Extensible Messaging and Presence Protocol (XMPP), Session Initiation Protocol for Instant Messaging and Presence Leveraging Extensions (SIMPLE), and/or Instant Messaging and Presence Service (IMPS), and/or Short Message Service (SMS), or any other suitable communication protocol, including communication protocols not yet developed as of the filing date of this document.

The memory 204 may include high-speed random access memory and may also include non-volatile memory, such as one or more magnetic disk storage devices, flash memory devices, or other non-volatile solid-state memory devices. Access to memory 204 by other components of the device 101, such as the CPU 202 may be controlled by the memory controller.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise rearranged in various embodiments.

In some embodiments, memory 204 may store a subset of the modules and data structures identified above. Furthermore, memory 204 may store additional modules and data structures not described above.

Attention is now directed toward embodiments of method of goods and services promotion that may be implemented on the computer systems 101 and 102.

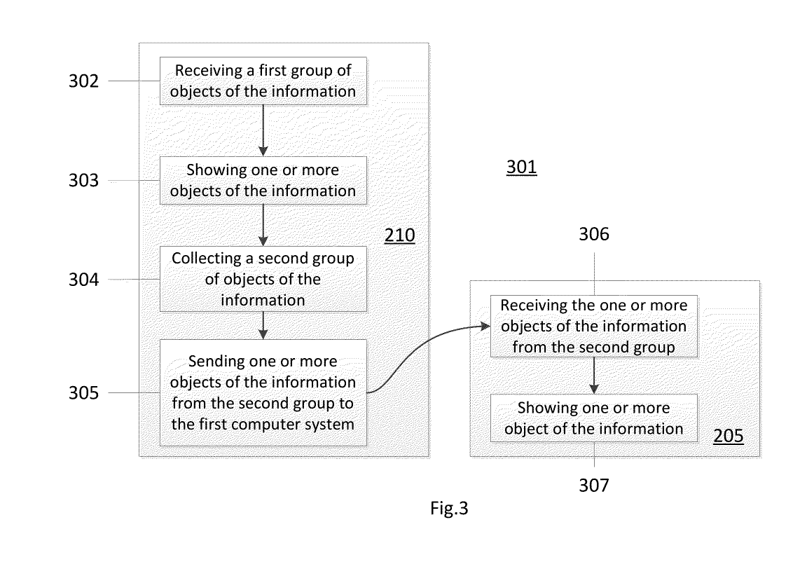

FIG. 3 is a block diagram illustrating a method of goods and services promotion in accordance with some embodiments of the present invention. The method 301 may be performed by a processing logic that may comprise hardware (circuitry, dedicated logic, etc.), software (such as is run on a general purpose computer system or a dedicated machine), or a combination of both. According to the exemplary embodiment, the method 301 is implemented on two computer systems, more particularly, on the smartphone 101 and on the personal computer 102. The method 301 comprises six steps.

In the beginning, the personal computer 102 receives a first group of objects of the information 302, by means of the network device 208, from the smartphone 101. The first group comprises one or more objects of the information. The objects of the information either from the first or the second group of the objects of the information might be represented in the form of or combination of: text, image, video record, audio record, web-page, HTML page, geographical location of the first computer system, geographical location of the second computer system, SMS message, symbols, trademarks, logotypes or any other data representation, including data representations not yet developed as of the filing date of this document.

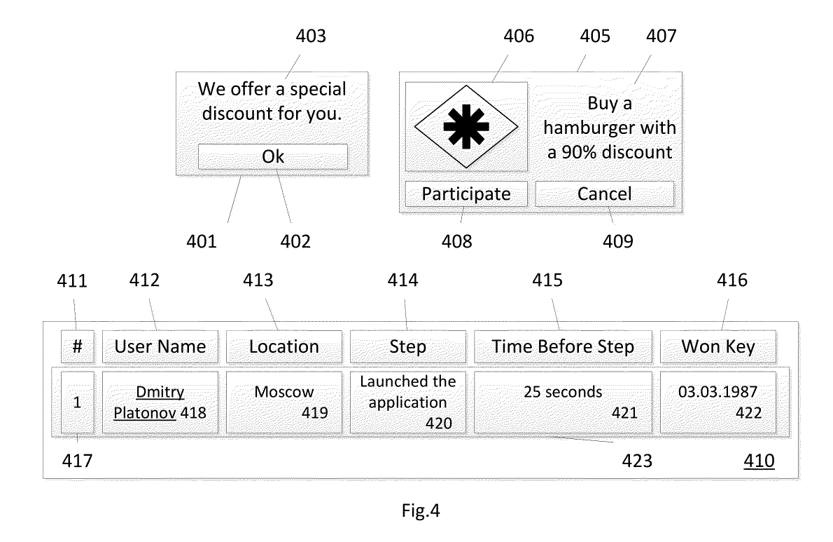

FIG. 4 illustrates examples of the objects of the information. Objects of the information might be represented in the form of:
a pop-up message 401, containing a text message 403 and a button 402. After clicking on the button 402, the device 101 returns to the previous state. The previous state in this context means a graphical user interface, which was displayed on the device 101 before it received the pop-up message 401;
a complex graphical user interface 405, which contains a text message 407, a brand logotype 406 of the company, which offers a discount, participate button 408 and cancel button 409. If the user clicks on the button 408, the computer system will display the description of the proposal. If the user clicks on the button 409, the computer system returns to the previous state.
a table 410, which contains following columns:
   “#” 411, which indicates the number of the row;
   “User name” 412, which contains a part of personal information about the user of the computer system;
   “Location” 413, which indicates the geographical location of the computer system;
   “Step” 414, which indicates another part of the personal information about the user of the computer system;
   “Time before step” 415, which indicates yet another part of the personal information about the user of the computer system;
   “Won key” 416, which indicates the last part of the personal information about the user of the computer system.

The table 410 consists of the row 423. The row 423 comprises the following cells:
cell 417, which contains the number “1,” indicating that the row 423 is the first row in the table 410;
cell 418, which contains the text “Dmitry Platonov,” indicating that the full name of the user of the computer system is Dmitry Platonov;
cell 419, which contains the text “Moscow,” indicating the geographical location of the computer system;
cell 420, which contains the text “Launched the application,” indicating the action that was performed on the computer system;
cell 421, which contains the text “25 seconds,” indicating the amount of time that the user of the computer system spent before the previous action on the computer system;
cell 422, which contains the text “03.03.1987,” indicating the special key for interaction between the company and the potential customer. Such a key can be used as a coupon code or a contract number. The above said key might contain numeric symbols, special symbols and letters from Latin, Cyrillic and other alphabets. Additionally, the above-mentioned key might comprise zero or more characters.

It should be appreciated that the objects of the information shown in FIG. 4 are only examples of the objects of the information and the present invention should not be limited to these particular examples. Text and images may vary, depending on the promo-campaign and users of the first or second computer system.

Upon receiving the first group of objects of the information, the personal computer 102 shows 303, which is one or more objects of the information to the user of the personal computer 102 on the display device of the personal computer, for example, in the form of the table 410. The cell 418 contains the full name of the user of the device 101 and the identifier of the device 101. As used herein, the term “computer system identifier” means the identification data, which is used for locating the computer system among the plurality of computer systems in a network or on the Internet, and establishing a network connection to/from the computer system. Identifier of the computer system might include, but is not limited to the IP address of the computer system, e-mail address of the user of the computer system, IMEI number of the computer system, cellphone number of the computer system and login information of the user of the computer system. According to the exemplary embodiment, the identifier of the device 101 is stored in the link “Dmitry Platonov.” Upon clicking on the link “Dmitry Platonov” in the cell 418, the personal computer 102 will display information about the user with the name “Dmitry Platonov.”

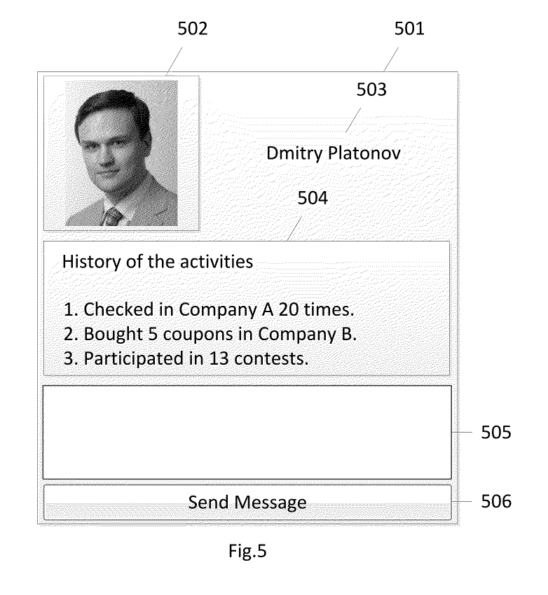

An example of the graphical user interface with information about the user of the device 101 is illustrated in FIG. 5. Graphical user interface 501 comprises:
a photo 502, assigned to the user of the device 101;
the full name 503, of the user of the device 101;
a history of the activities 504, of the user of the device 101;
an input window 505, which is used to type a message to the user of the device 101;
a “Send Message” button 506, which is used to send a message from the input window 505, to the user of the device 101.
   It should be mentioned that the information displayed in graphical user interface 501 is a different type of objects of information, that was sent from the device 101. Additionally, the personal computer stores a device identifier in the link 418 or in the memory 209.

The history of the activities 504 represents statistics information about the activity of the user with the name “Dmitry Platonov.” In this particular embodiment, the history of the activities 504 shows that Dmitry Platonov checked in Company A twenty times, bought five coupons from Company B and participated in thirteen contests. The graphical user interface 501 also comprises a text field 505 and a “Send Message” button 506. The elements 505 and 506 will be described below.

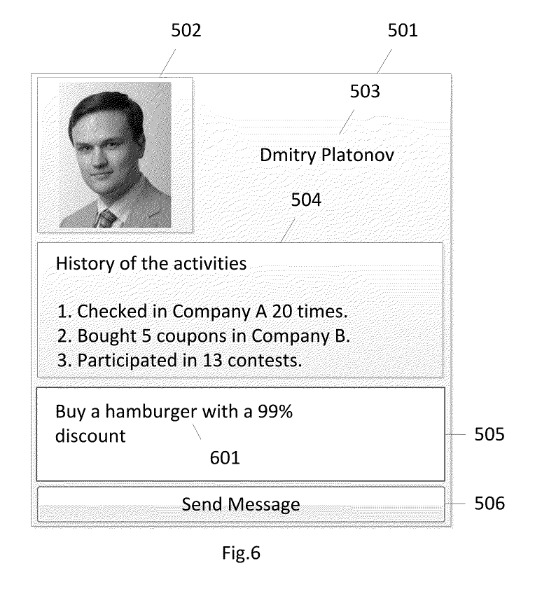

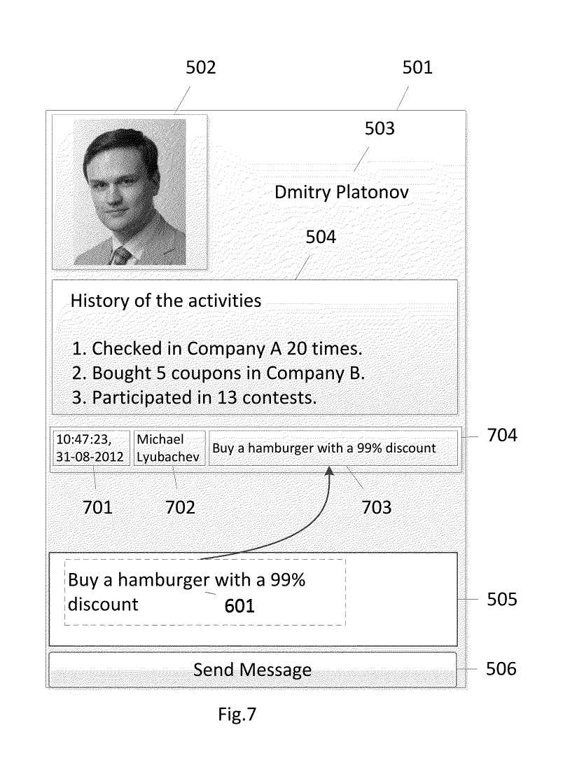

To promote goods and/or services to the user of the device 101, the user of the personal computer 102 has to collect objects of the information 304. To perform the task of getting a second group of objects of the information, in this exemplary embodiment, the user of the personal computer 102 clicks on the link in the cell 418. The personal computer opens the graphical user interface 501. The user of the personal computer types a message into the text field 505 and clicks the button 506. For the purposes of explanation, it is assumed that the user of the personal computer typed the following message 601, illustrated in FIG. 6: “Buy a hamburger with a 99% discount.” Upon clicking on the button 506, the personal computer 102 performs the following actions:
sends 305 the message from the text field 505 along with the title of the company and name of the user of the personal computer;
adds the message 601 from the text field 505 along with the time when the message 601 was sent to the user of the device 101. An example of the modified graphical user interface is illustrated in FIG. 7;
saves the message 601 and the time when the message was sent, to the memory 209;
deletes the message from the text field 505.

FIG. 7. illustrates an example of message log placement on graphical user interface with information about the user. After the user of the device 101 receives the message, the personal computer adds a new row 704 to the graphical user interface 501. The row 704 comprises a time stamp 701, full name of the user of the personal computer 702 and message 703, which was sent to the user of the smartphone.

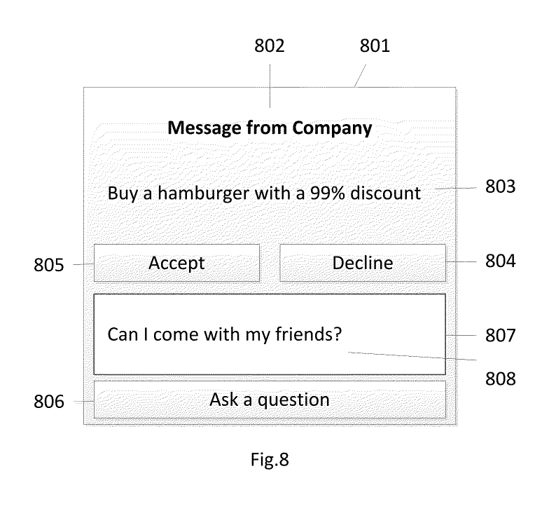

The smartphone receives 306, by means of a network device 203, the message 601, the title of the company and name of the user of the personal computer. Upon receiving all or part of the above information from the personal computer, the smartphone shows 307 all or part of the received information on the touch-screen display 201. In this exemplary embodiment, the smartphone displays all the information in the window as shown in FIG. 8. It should be appreciated that the window shown in FIG. 8 is only one example of the type of data representation and the present invention should not be limited to only this particular example.

FIG. 8 illustrates a window which is shown to the user of the device 101 according to some embodiments of the present invention. The window 801 comprises the title 802 of the message, message body 803, text field 807, “Accept” button 805 and “Decline” button 804. In this particular exemplary embodiment, the title of the message was generated automatically by the personal computer after the user of the personal computer clicked on the button 506. In other embodiments of the present invention, the title of the message 802 might be generated automatically by the device 101 or inputted by the user of the computer system 102.

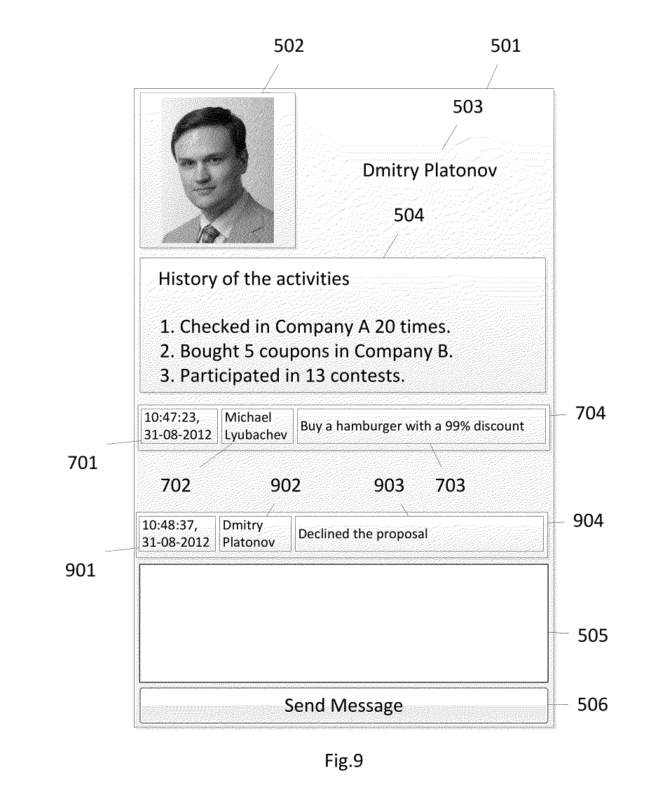

If the user of the smartphone clicks on the button 804, the smartphone sends to the personal computer the message “Declined the proposal” along with the time stamp. When the personal computer receives this information, it adds a new row to the graphical user interface 501. The example of the modified graphical user interface is illustrated in FIG. 9. Upon receiving the message from the user of the smartphone, the personal computer adds a new row 904 to the graphical user interface 501. The row 904 comprises a time stamp 901 that shows the time the message was sent from the smartphone, the full name 902 of the user of the smartphone and the message body 904. In this exemplary embodiment, the message 904 was generated automatically by the smartphone after the user clicked on the button 804.

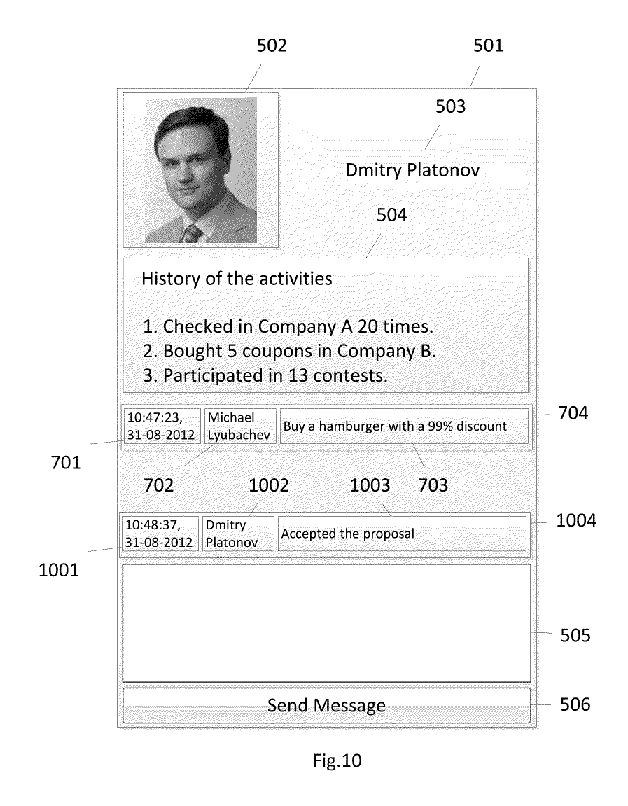

If the user of the smartphone clicks on the button 805, the smartphone sends to the personal computer the message “Accepted the proposal” along with the time stamp. Upon receiving the above said information, the personal computer adds a new row to the graphical user interface 501. The example of the modified graphical user interface is illustrated in FIG. 10. Upon receiving the message from the user of the smartphone, the personal computer adds a new row 1004 to the graphical user interface 501. The row 1004 comprises a time stamp 1001 of the time that the message was sent from the smartphone, the full name 1002 of the user of the smartphone and the message body 1004. In this exemplary embodiment, the message 1004 was generated automatically by the smartphone after the user clicked on the button 805.

The text field 807 is used for sending feedback or a question to the user of the personal computer. In this particular exemplary embodiment, it is assumed that the user of the smartphone wants to ask the question, “Can I come with my friends?” To ask this question, the user of the smartphone types it in the text field 807 and clicks on the button 806. Upon clicking on the button 806, the smartphone gets information about the time, date, geographical location, full name of the user of the smartphone and the message 808. After all the above information is collected, the smartphone sends it to the personal computer. One part of the above information is appended to the table 410, another part is appended to the graphical user interface 501.

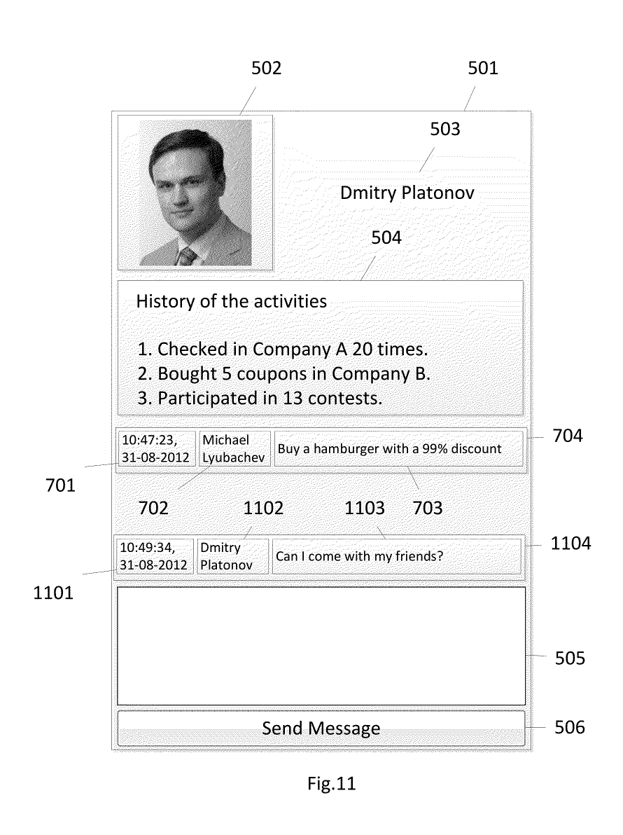

FIG. 11 illustrates modified graphical user interface 501 with the message from the user of the first computer system, according to some embodiments. When the personal computer receives the message 808, it adds a new row 1104 to the graphical user interface 501. The row 1104 comprises a time stamp 1101, full name of the user of the smartphone 1102 and the message 1103. In this particular embodiment, the personal computer appends the new row 1104 under the row 704 and saves the data from the cells 1101, 1102 and 1103 to the memory of the personal computer. In some embodiments, the data might be deleted after a certain amount of time, for example, one month after receiving it. In some embodiments, the second computer system saves the received message 808 to the database and then adds the new row 1104 to the graphical user interface 501. In some embodiments, the personal computer saves the received message 808 to the memory of the personal computer and then adds the new row 1104.

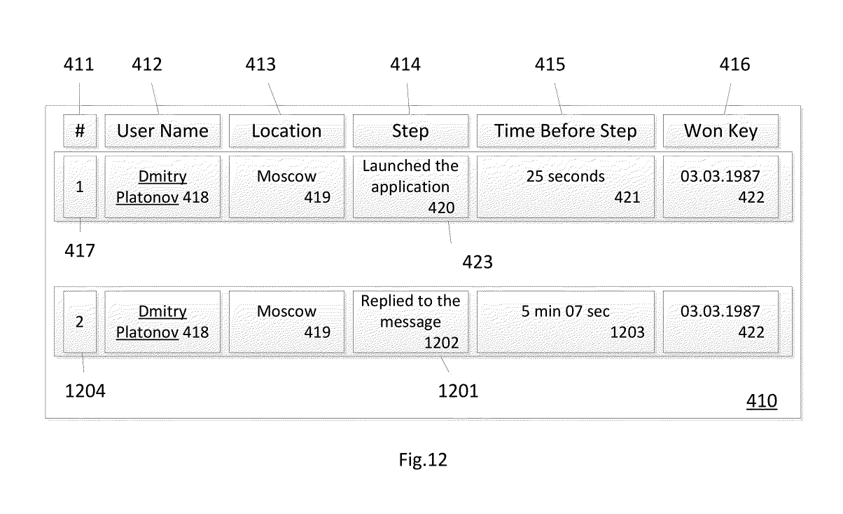

FIG. 12 illustrates a graphical user interface with the table, which comprises information about the user, after the first computer system sends the message to the second computer system, according to some embodiments of the present invention. As was mentioned above, in some embodiments the personal computer divides the information received from the smartphone into two parts. One of these parts is illustrated in FIG. 12. Upon receiving information from the smartphone, the personal computer adds a new row 1201 to the table 410. The new row 1201 comprises:
the cell 1204, which contains the following information: “2,” indicating that the row 1201 is the second row in the table 410;
the cell 418, which contains the following information: “Dmitry Platonov.” The information in the cell 418 is underlined, because it contains a link to the user profile page. In some embodiments, the link additionally contains a unique identifier of the first computer system, which might be used for remote connection creation or management;
the cell 1202, which contains the following information:

“Answered the message,” indicating that the user of the smartphone has sent a message to the user of the personal computer;
the cell 1203, which contains the following information: “5 min 07 sec,” indicating that the user of the smartphone spent five minutes and seven seconds after the previous action and before sending the message to the user of the personal computer;
the cell 422, which contains the following information: “03.03.1987,” indicating a special code, which might be used for discount payment or good and/or services purchase.
   It should be noted that in some embodiments, the table might comprise other columns and therefore other parts of the information received from the first computer system will be distributed to the table 401.

In some embodiments of the present invention, the first computer system 101 and the second computer system 102 can be represented accordingly by a first portable multifunction device, owned by a taxi-driver, and a second portable multifunction device, owned by a potential client.

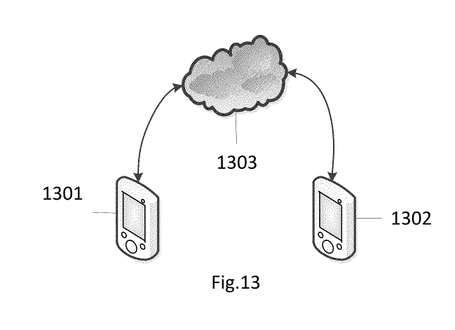

FIG. 13 illustrates interaction between computer systems according to some embodiments of the present invention. To promote taxi services, the user of the first computer system 1301 establishes a connection to the remote computer system 1303 and publishes a promo-campaign on the remote computer system 1303. In this exemplary embodiment, the remote computer system 1303 acts as a central location for communication between users of the computer systems. Specifically, the remote computer system 1303 stores information about promo-campaigns of various users, communicates with computer systems, sends and receives messages related to promo-campaigns from various computer systems, distributes information among the computer systems and stores user profiles and logs of the messages associated with users. The present invention should not be limited to the above description of the remote server. In some embodiments, the remote server can be located in the first computer system 101, or in the second computer system 102 or on the Internet. It should be noted that the term “Internet” refers to a network of networks. Such networks may use a variety of protocols for exchange of information, such as TCP/IP, ATM, SNA, SDI, etc. The physical connections of the Internet and the protocols and communication procedures of the Internet are well known to those in the field. It should be noted that such systems may also be implemented in the intranet within an organization. In some embodiments, the remote server can be divided into two or more parts and located in the first computer system as well as the second computer system.

The connection between the first portable multifunction device and the remote server can be established by means of the communication module of the first portable multifunction device or by SMS.

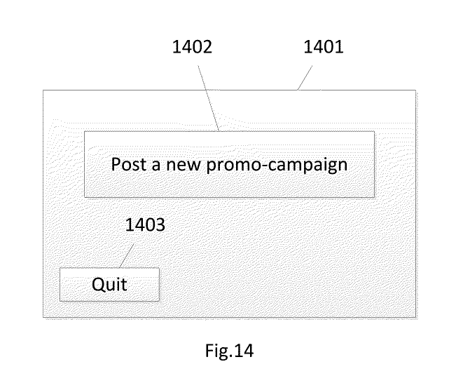

FIG. 14 illustrates a graphical user interface, shown on the first computer system, according to some embodiments. The graphical user interface 1401 comprises the button “Post a new promo-campaign” 1402 and the button “Quit” 1403. The button 1402, according to this exemplary embodiment, is used to begin the publishing of the new promo-campaign process. The button 1403, according to this exemplary embodiment, is used to quit the software application.

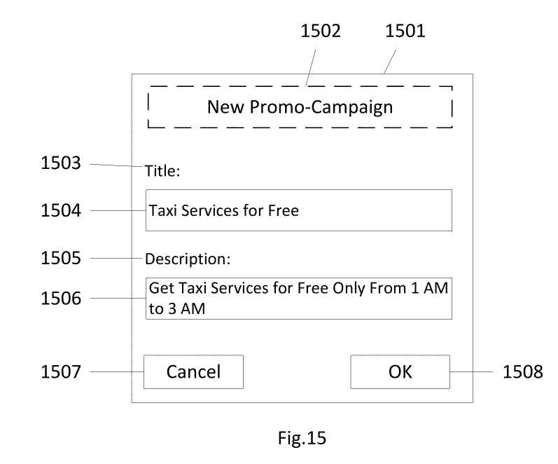

Upon clicking on the button 1402, the first portable multifunction device shows the graphical user interface, illustrated in FIG. 15. According to some embodiments, the graphical user interface 1501 comprises:
the title 1502 of the graphical user interface 1501;
the title 1503 of the text field 1504;
the text field 1504, which is used to input a promo-campaign title;
the title 1505 of the text field 1506;
the text field 1506, which is used to input a promo-campaign description;
the button 1507, which is used to cancel the creation of a new promo-campaign and
the button 1508, which is used to publish the new promo-campaign.
   In some embodiments, the graphical user interface 1501 might comprise additional fields, such as geographical location, prices, limitation of the amount of offers, time limitation of the promo-campaign, preferences about potential customers, such as sex, age, location, buying history.

Upon clicking on the button 1507, the portable multifunction device returns to the graphical user interface 1401. Upon clicking on the button 1508 in this exemplary embodiment, the first portable multifunction device 1301 collects information about the user of the first portable multifunction device, information from the text fields 1504 and 1506, and information about the current geographical location of the first portable multifunction device 1301. After all or part of the above described information is collected, the first portable multifunction device 1301 sends the collected information to the computer system 1303.

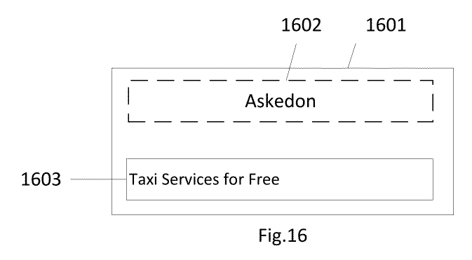

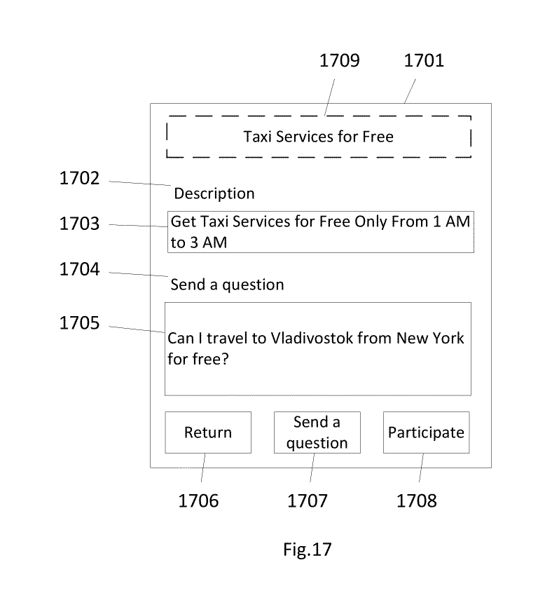

Upon launching one or more programs on the second portable multifunction device 1302, the one or more programs send a request to the computer system 1303. For purposes of explanation, the request is used to get information about new promo-campaigns. Upon receiving the above-mentioned request from the second portable multifunction device 1302, the computer system 1303 checks if it contains new promo-campaigns. If the computer system doesn't contain any new promo-campaign, the computer system 1303 sends a response to the second portable multifunction device 1302 notifying it that the computer system 1303 doesn't contain new promo-campaigns. In this exemplary embodiment, the computer system 1303, as was mentioned above, contains one new promo-campaign from the user of the first portable multifunction device 1301. Accordingly, upon receiving the above-mentioned request, the computer system 1303 gets all or part of the information about the one or more new promo-campaigns. In this exemplary embodiment, the computer system 1303 sends all the information received from the first portable multifunction device 1301 to the second portable multifunction device 1302. Upon receiving at the second portable multifunction device 1302 all or part of the above mentioned information, the second portable multifunction device 1302 displays the graphical user interface that is shown in FIG. 16. The graphical user interface 1601, shown in FIG. 16, is used herein for purposes of explanation only and should not limit the present invention. The graphical user interface 1601 comprises the brand name of the company 1602, the list of the promo-campaigns 1603 and the button “Return” 1604. Upon clicking on the brand name, the second portable multifunction device 1302 will close one or more programs and open a web-browser at the page of the company. Upon clicking on the button 1603, the second portable multifunction device 1302 displays the graphical user interface shown in FIG. 17.

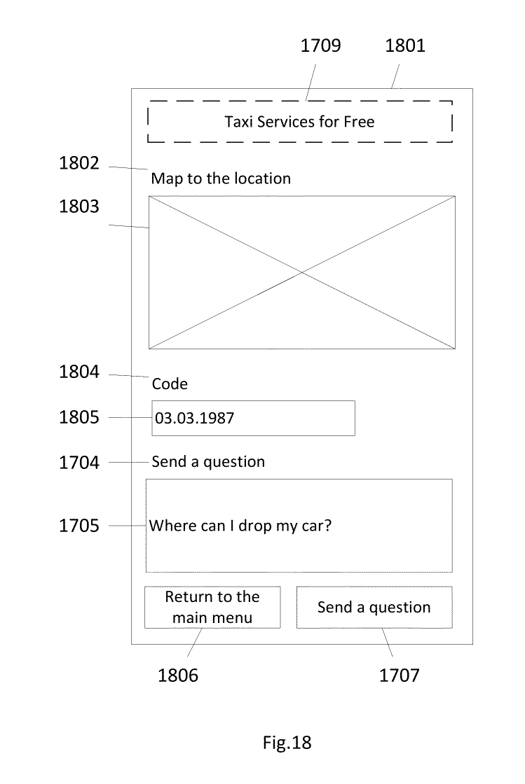

The graphical user interface 1701, in this exemplary embodiment, comprises:
the title of the promo-campaign 1709;
the title of the description section 1702;
the description text 1703, which was downloaded from the computer system 1303;
the title of the interaction section 1704;
the text field 1705, which is used for interaction between the user of the first portable multifunction device 1301 and the user of the second portable multifunction device 1302;
the button “Return” 1706. Upon clicking on the button 1706, the second portable multifunction device 1302 returns to the previous state and, according to this exemplary embodiment, shows the graphical user interface 1601;
the button “Send a question” 1707. Upon clicking on the button 1707, the second portable multifunction device 1302 gets all the information inputted to the text field 1705 and sends it along with information which characterizes the user of the second portable multifunction device 1302 and the second portable multifunction device 1302, and geographical location of the user of the second portable multifunction device 1302, to the first portable multifunction device 1301 through the computer system 1303;
the button “Participate” 1708. Upon clicking on the button, the second portable multifunction device displays the graphical user interface shown in FIG. 18.
   In some embodiments of the present invention, the graphical user interface might contain one of the following items or combination of the following items: the brand name of the company, logotype of the company, geographical location of the user of the first portable multifunction device 1301, path to the location of the user of the first portable multifunction device 1301, the price of the services and/or goods, the discount rate of the promo-campaign, the button which can be used for on-the-fly payment for the services and/or goods or coupon, the feedback tab where customers of the services and/or goods can publish their feedback and set the rating of the services and/or goods, the rating given by the customers of the current promo-campaign, the address details, the cellphone number, the e-mail address, the phone number, the identification number, the button which can be used to report to the computer system 1303 administrator that the promo campaign contains text and/or images and/or sound record and/or video record prohibited by rules or to report if the user of the first portable multifunction device 1301 used text and/or images and/or sound record and/or video record prohibited by rules.

The graphical user interface 1801, according to some embodiments, comprises:
the title of the promo campaign 1709;
the title of the map section 1802;
the map 1803 (not shown). The map 1803 can be used to determine the location of the user of the first portable multifunction device 1301 and the path from the location of the second user of the portable multifunction device 1302 to the location of the first user of the portable multifunction device 1301;
the title of the code section 1804;
the text field 1805, which contains the code. The code might contain one or more numbers, characters or special characters, either in lower case or upper case, or a combination thereof. The code can be used to redeem the coupon and/or purchase goods and/or services from the promo-campaign. According to some embodiments of the present invention, the code in the text field can be generated automatically by the computer system 1303, manually by the user of the first portable multifunction device 1301, manually by the user of the second portable multifunction device 1302, manually by the user of the computer system 1303, automatically by the first portable multifunction device 1301, automatically by the second portable multifunction device 1302 or a combination of all or any of these. The code generated by the first and second portable multifunction device 1301 and/or computer system 1303 can be stored in the devices 1301 and 1303 accordingly after the code generation process is completed, or can be sent to the second portable multifunction device 1302 without saving to the memory of the first portable multifunction device 1301 and/or computer system 1303. In some embodiments, the code can be divided into two or more parts and stored in one or more computer systems. In some embodiments, one or more parts of the code can be generated on the first computer system, second computer system and/or third computer system or a combination thereof. For example, the first part of the code “DmitryPlatonov-” can be generated on the first computer system and the last part “03.03.1987” on the second computer system. So, in this example, the code “DmitryPlatonov-03.03.1987” comprises two parts, the first part “DmitryPlatonov-” generated on the first computer system and the second part “03.03.1987,” generated on the second computer system. In some embodiments, one or more parts of the code can be stored in the memory and/or database of the computer system where the above-mentioned one or more parts were generated.
the title of the feedback section 1704;
the text field 1705 where the user of the second portable multifunction device can input a question or a proposal to the user of the first portable multifunction device. In some embodiments of the present invention, the feedback section can additionally contain the elements of the graphical user interface, which can be used to upload to the computer system 1303 and, therefore, send one or more files to the user of the first computer system 1301. In some embodiments, the graphical user interface 1801 can comprise additional elements, which can be used for marketing, advertisement, including third party advertisement, the brand name of the company, a logo of the company, a video record, an audio record and an image. In some embodiments, after the user of the second portable multifunction device chooses one or more files to send to the user of the first portable multifunction device, the graphical user interface 1801 displays part or all contents of the chosen one or more files;
the button “Return to the main menu” 1806, which can be used to open the graphical user interface 1601, which appears after launching, at the second portable multifunction device 1302, one or more programs. In some embodiments, the button 1806 can switch back to the previous graphical user interface, which appeared before the graphical user interface 1801;
the button “Send a question” 1707, which can be used to send a question to the user of the first portable multifunction device 1301 from the text field 1705.
   In some embodiments, the graphical user interface 1801 has an additional button, which can be used to show the graphical user interface that appeared before the graphical user interface 1801.

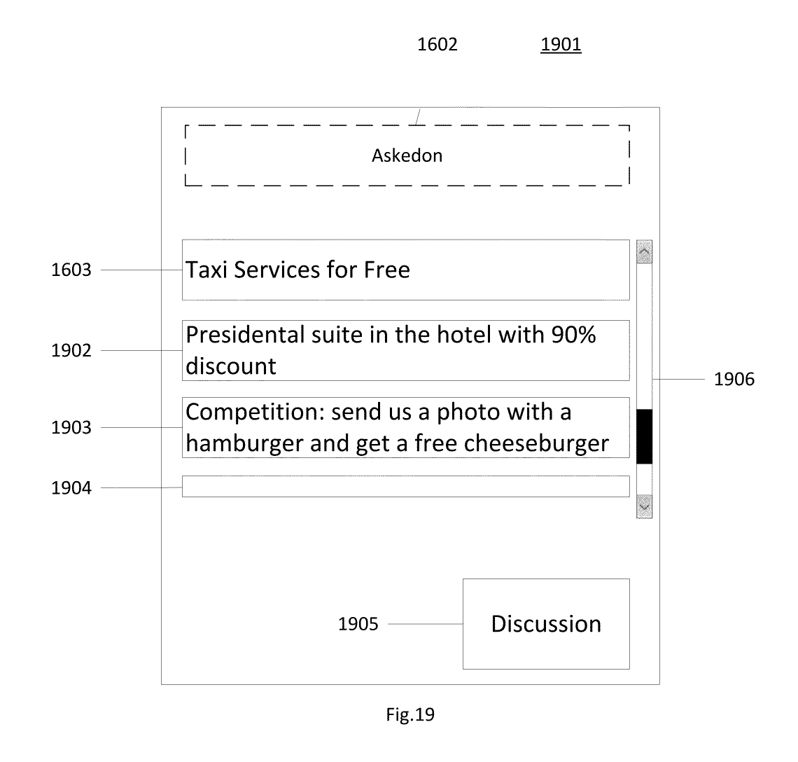

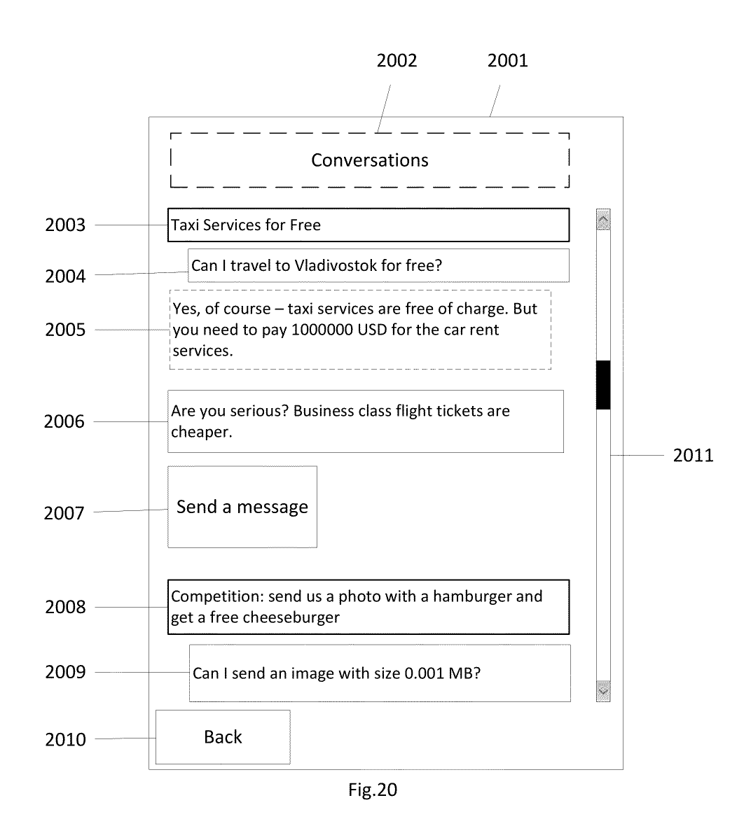

In some embodiments, the graphical user interface 1601 has an additional section “Discussion,” which can be used to continue and track the discussion between the user of the first computer system and the user of the second computer system. The modified graphical user interface is shown in FIG. 19. The graphical user interface 1901 comprises the following elements:
the title of the one or more programs 1602;
the title of the first proposal 1603;
the title of the second proposal 1902;
the title of the third proposal 1903;
the title of the fourth proposal 1904. The region that is dedicated for display of the proposal has a limited size. The title of the fourth proposal 1904 is hidden because it overlaps the borders of the region. To read hidden titles of other proposals, the user needs to push the scroll tab 1906 to the bottom. In some embodiments, the computer systems can have a touch-screen display. Using a touch-screen display, the user can navigate through the graphical user interface using fingers and/or stylus.
the button “Discussion” 1905. The button 1905 can be used to open a new graphical user interface where the user can track discussions and begin new ones, or extend a graphical user interface 1901 and display previous conversations. According to some embodiments of the present invention, upon clicking on the button 1905, the second computer system will display a graphical user interface as shown in FIG. 20.

The graphical user interface 2001 comprises the following elements:
the title 2002 of the graphical user interface 2001;
the first title 2003 of the promo-campaign (marked with bold borders);
the first question 2004, related to the first promo-campaign with the title 2003, from the user of the first computer system 101 to the user of the second computer system 102 (marked with standard borders);
the answer 2005, to the first question 2004, from the user of the second computer system 102 (marked with dashed borders);
the text field 2006, which can be used by the user of the first computer system 101 to write a new question to the user of the second computer system 102 and to continue the conversation;
the button 2007, which can be used to send a message from the text field 2006 to the second computer system 102;
the second title 2008 of the promo-campaign;
the first question 2009, related to the second promo-campaign with the title 2008, from the user of the first computer system 101 to the user of the third computer system;
   The answer to the first question 2009 and other questions and answers related to the second promo-campaign with the title 2008, as well as other questions and answers related to other promo-campaign are not visible in FIG. 20. The user of the first computer system can use a scroll bar to navigate through the user interface and find the necessary question or answer or write a new question or answer. The structure of the questions and answers section for one promo-campaign, according to some embodiments, are characterized by the elements 2003, 2004, 2005, 2006, 2007. The question and answer section for other promo-campaigns, according to some embodiments, have the same structure as mentioned above. The user of the first computer system can use the button 2010 to navigate back to the previous graphical user interface that appeared before the graphical user interface 2001. In this particular embodiment, the previous graphical user interface is the graphical user interface 1901.

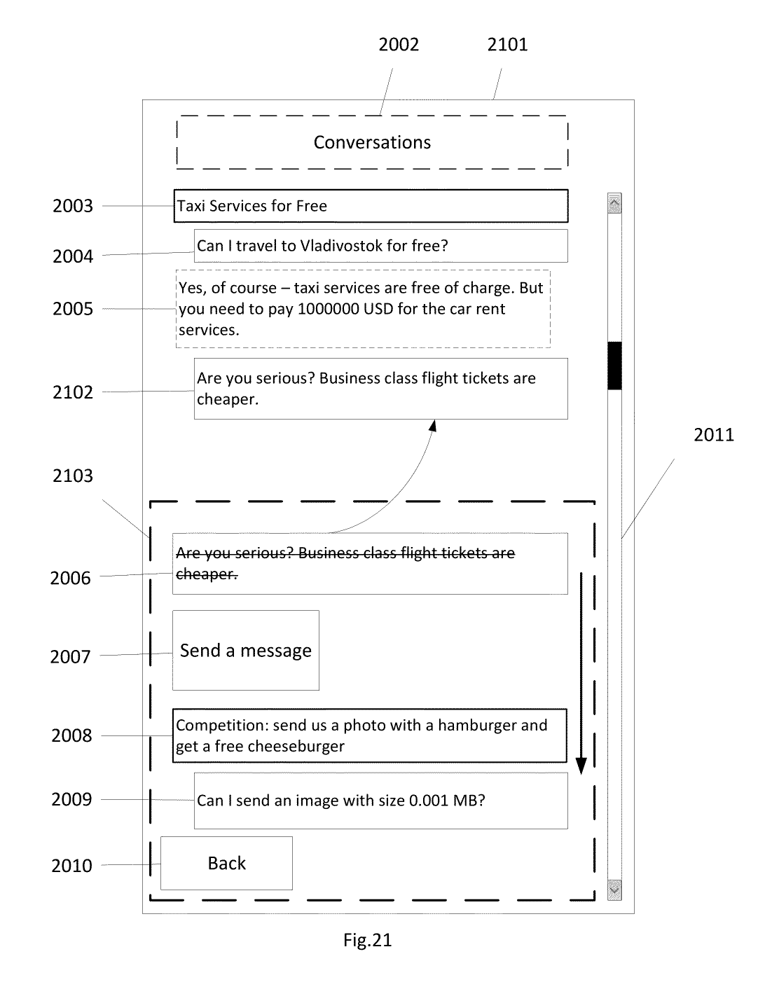

Upon clicking on the button 2007, the first computer system 101 modifies the graphical user interface 2001. The example of the modified graphical user interface 2001 is shown in FIG. 21. Upon clicking on the button 2007, the first computer system:
sends data from the text field 2006 to the user of the second computer system 102;
clears the contents of the text field 2006;
moves the section 2103 down;
places the data from the text field 2006 to the according section. In this exemplary embodiment, the first computer system appends a text message 2102 to the first promo-campaign 2003 section;
   In some embodiments, the graphical user interfaces 2001 and 2101 can comprise an additional one or more elements, for example, one or more elements that can be used to upload one or more images; one or more elements that can be used to upload one or more sound records; one or more elements that can be used to upload one or more video records; one or more elements that can be used to delete one or more messages from the conversation; one or more elements that can be used to delete one or more images; one or more elements that can be used to delete one or more sound records; one or more elements that can be used to delete one or more video records; one or more elements that can be used to delete one or more promo-campaign sections; one or more elements that can be used to share the conversation with the third party computer system; one or more elements that can be used to send one or more messages from the conversation by e-mail; one or more elements that can be used to report objectionable content; one or more elements that can be used to synchronize the conversation with the third party computer system; one or more elements that can be used to rate one or more promo-campaigns; one or more elements that can be used to access information about the user and/or company of the second computer system; one or more elements that can be used to generate an automatic answer and/or question; one or more elements that can be used to access information about a promo-campaign; one or more elements that can be used to pay for an offer from a promo-campaign; one or more elements that can be used to pay for the one or more third parties for an offer from a promo-campaign; one or more elements that can be used to invite one or more third parties and organize a group; one or more elements that can be used to access special promo-campaigns oriented toward groups of two or more members; one or more elements that can be used to search for additional information about the promo-campaign; one or more elements that can be used to search for one or more users of other one or more computer systems; one or more elements that can be used to mark the user of the first computer system as a user who wants to enter into the group and/or to find a group which needs one or more additional members; one or more elements that can be used to send feedback about the one or more programs 205; one or more elements that can be used to create an appointment; one or more elements that can be used to synchronize the date of the promo-campaign events or offers with the calendar of the one or more third party computer systems; one or more elements that can be used to pay for an offer from a promo-campaign using one or more third party programs; one or more elements that can be used to pay for an offer from a promo-campaign using one or more devices; one or more elements that can be used for a promo-campaign creation; one or more elements that can be used to pay for a promo-campaign creation; one or more elements that can be used for promo-campaign promotion; one or more elements that can be used to pay for changing the position of the promo-campaign; one or more elements that can be used to pay for a rating of the promo-campaign, one or more elements that can be used to pay for an offer from the promo-campaign by plastic card.

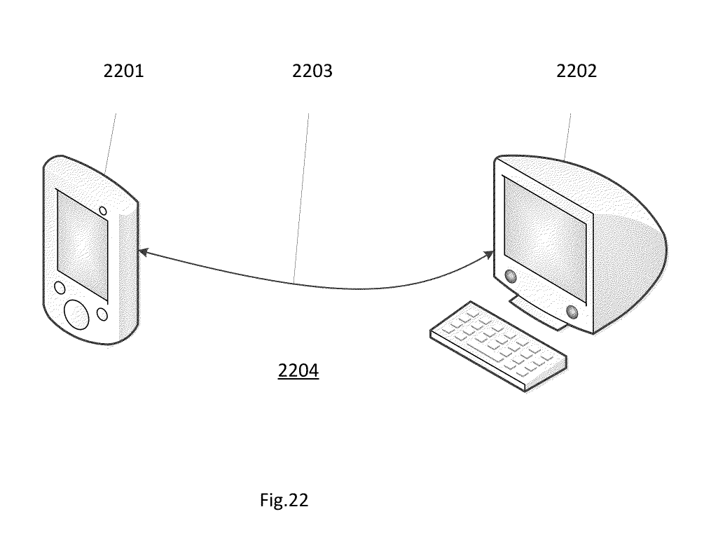

In some embodiments, the present invention can be used for hotel room reservations. FIG. 22 shows the exemplary system that can be used in hotels and by a user who wants to make a room reservation or booking. The system 2204 comprises the following elements:
the first device 2201, that can send and receive 2203 data from one or more remote computer systems and store data in the memory;
the second device 2202, that can send and receive 2203 data from one or more remote computer systems, store data in the memory and show the data on the display device.

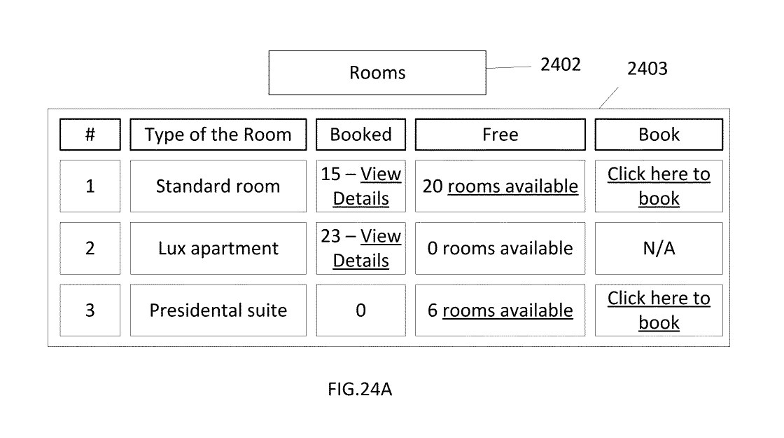

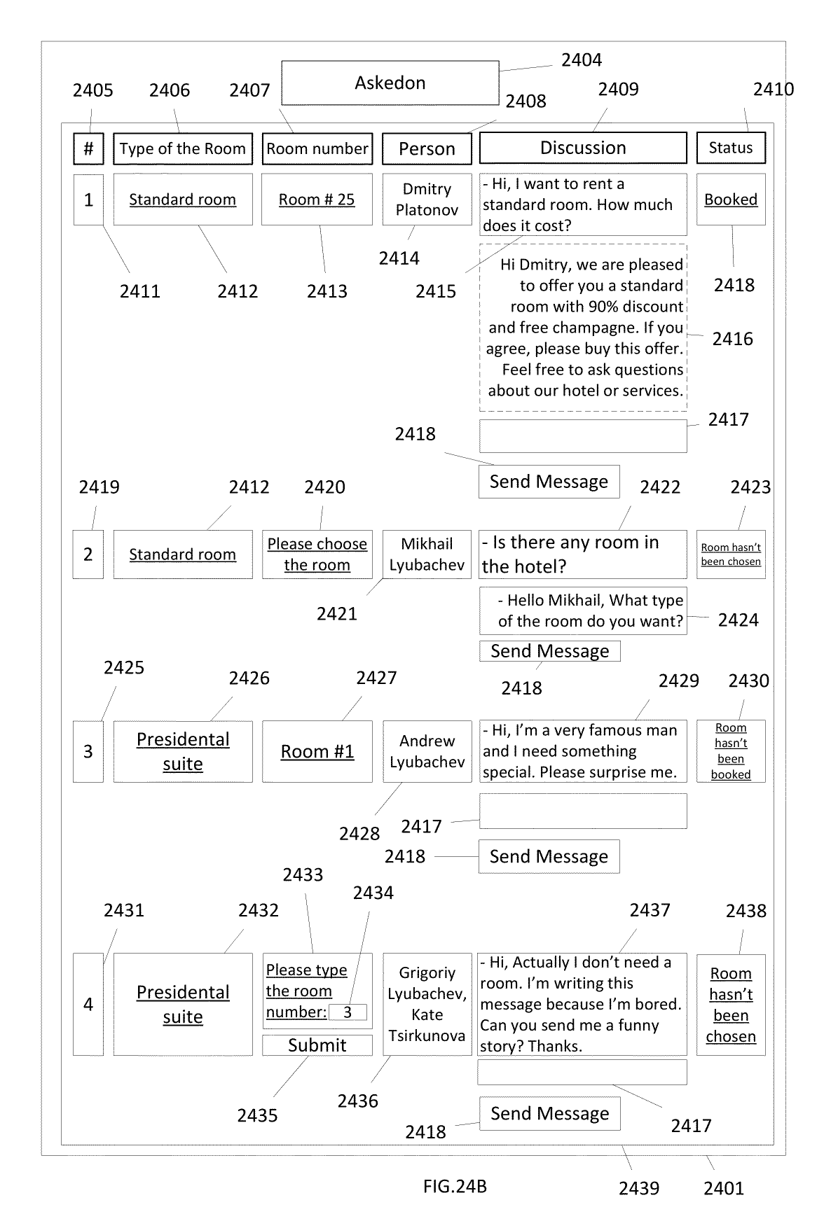

FIG. 24A and FIG. 24B contain an exemplary user interface of one or more programs, which implement the present invention and can be used in the hotel to promote one or more hotel rooms. The graphical user interface 2401 comprises two sections. The first section comprises the first section header 2402 and the table 2403 with information about rooms in the hotel. The table 2403 contains information about room types, status of the room reservation—free or booked, the amount of free or booked rooms. Using the table 2403, the user of the computer system on which the graphical user interface 2401 is shown, can book the free room and review, by clicking on the link “View Details,” the location of the booked or free room.

The second section comprises the second section header 2404 and the table 2439. In this exemplary embodiment, the table 2439 comprises the following columns:
the column with title “#” 2405, which indicates the row number;
the column with title “Type of the room” 2406, which indicates the type of the room and which is a subject for booking;
the column with title “Room number” 2407, which indicates the room number of the room to be booked in the hotel;
the column with title “Person” 2408, which indicates the identity of the person who wants to book a room in the hotel;
the column with title “Discussion” 2409, which contains the messages exchanged between the person who wants to book a room and a hotel employee. In this exemplary embodiment, messages from the person who wants to book a room in the hotel have a solid border and the text is aligned to the left; messages from the hotel employee have a dotted border and the text is aligned to the right. Additionally, the column 2409 comprises the text field, e.g., 2417, 2424, which is used to input the message to the person who wants to book a room in the hotel, and the button “Send Message” 2418, which is used to send the message from the text fields, e.g., 2417, 2424.
the column with title “Status” 2410, which contains the current status of the room.

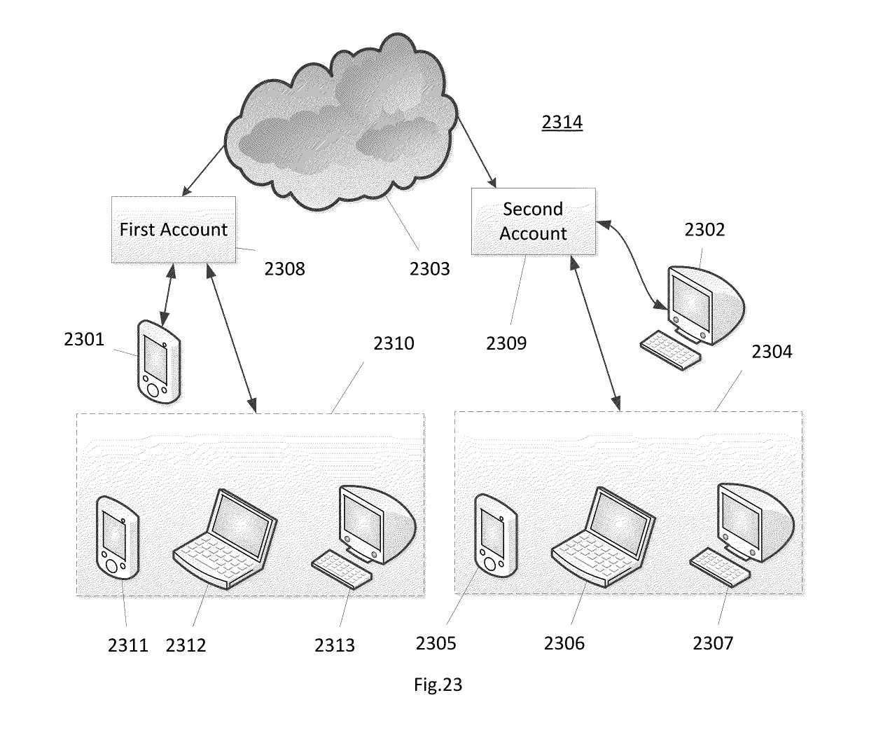

The first row of the table 2439 comprises the following cells:
the cell 2411 contains the data “1,” which indicates the number of the row.
the cell 2412 contains the data “Standard room,” which means that the type of the room, “Standard room,” is the subject for booking. According to this exemplary embodiment, the computer system, which executes one or more programs, and which shows the graphical user interface 2401, automatically assigns an available free room to the new discussion which was initiated by the user of the portable multifunction device (not shown in FIG. 24) or the hotel employee. The computer system that executes one or more programs, which shows the graphical user interface 2401, for purposes of explanation is called “Hotel computer system.” The cell 2412 contains a link, by clicking on which the user of the hotel computer system can change the room. As will be described below, the user of the hotel computer system can change the room type manually by clicking on the link in the cell under column 2406.
the cell 2413 contains the room number which is the subject for booking. The data in the cell “Room #25” 2413 is underlined to illustrate, that, in some embodiments, the user of the hotel computer system can change the room number by clicking on the data in the cell 2413. In some embodiments, by clicking on the data in the cell 2413, the hotel computer system will show an interactive map of the hotel, which shows free and/or booked and/or busy rooms. Free, busy and booked rooms might be marked with different colors. When the user clicks on any room, the hotel computer system shows the room description and current status. Additionally, in some embodiments, the hotel computer system can show the elements which are similar to text field 2417 and button 2418, and can be used to send a message to the guest who booked the room chosen by the user of the hotel computer system. Also, in some embodiments, the hotel computer system can show the whole discussion between the user of the hotel computer system and the guest who booked the room chosen by the user of the hotel computer system. For example, the person who wants to book a room begins by searching for best prices across hotels. Using his portable multifunction device, for example, iPhone, Android phone, Windows phone smartphone, he opens an application. The application shows the nearest hotels and other companies that offer room rent services. After choosing the hotel and/or room type, the portable multifunction device shows the route to the place and a chat tab. The chat tab can be used for discussions about the offer. For example, if the person who wants to book a room wants to know if the hotel provides mineral water or candies or free food, he opens the chat tab and writes his question. In this case, the hotel computer system creates a new row, similar to the rows in the table 2401 and places it to the top or bottom of the table 2439. After the new row was added to the table 2439, the user of the hotel computer system can react to the message accordingly and promote the hotel services or make a special discount for the person who wants to book a room or order other hotel services.
the cell 2414 contains information about person who wants to book a room or purchase other hotel services.
the cells 2415, 2416, 2417, 2418 contain elements that are necessary for the discussion according to some embodiments. The cell 2415 contains the first message from the potential client. The cell 2415 has a solid border indicating that the message came from the potential customer. The cell 2416 contains the message written by the user of the hotel computer system and sent, by means of the communication module of the hotel computer system, to the computer system of the person who wants to book a room or purchase other hotel services. The cell 2416 has a dashed border indicating that the message was created by the user of the hotel computer system. The cell 2417 is a text field into which the user of the hotel computer system can input a new message to the person who wants to book a room or purchase other hotel services. The button 2418 is used to send the message which was inputted to the text field 2417 to the person who wants to book a room or purchase other hotel services. It should be understood that the elements 2415, 2416, 2417 and 2418 are described only for purposes of explanation and the present invention should not be limited to the above-mentioned elements. The elements for discussion might comprise one or combination of the following elements: one or more text fields, file upload elements, one or more links, one or more check boxes, one or more radio buttons, elements for the video playback, elements for the video record, coupon identification information.
the cell 2418 contains information about the status of the room which is the subject for booking. In this particular embodiment, the cell 2418 contains the following data “Booked.” The information in the cell 2418 is underlined, which means that the user of the hotel computer system can click on the text to get additional information about the status of the room. In some embodiments, this detailed information about status of the room can contain the history of discussions between the hotel employee and customer and/or potential customers, the rating of the room, as assigned by the customer, feedback messages from the customer, the price of the room, the location of the room, one or more photos of the room, one or more video records showing the room interior and/or exterior, one or more video records about the hotel.
   The second row comprises the following elements:
the cell 2419 contains the data “2,” which indicates the number of the row;
the cell 2412 contains information with a link about the room type of the room which is the subject for booking;
the cell 2420 contains information about the room number of the room which is the subject for booking. In this exemplary embodiment, the room number hasn't been chosen, so the cell 2420 contains the link. When the user of the hotel computer system clicks on the link in the cell 2420, the hotel computer system will show the list of rooms and/or the map of the rooms to the user of the hotel computer system. By clicking on the particular room from the list or map, the hotel computer system shows the description of the room. The description of the room contains the information about the room along with the elements mentioned above in the status window. Additionally, the description of the room contains the button to be clicked, which will allow the user of the hotel computer system to choose the room for the person whose information is mentioned in the cell 2421. In some embodiments, the user of the hotel computer system can choose the room by simply clicking on it in the list of the rooms and/or on the map of the rooms. The present invention should not be limited to the above-mentioned methods of choosing rooms.
the cell 2421 contains information about the person who wants to book a room or purchase other hotel services. In some embodiments, the cell 2421 can contain one or combination of the following: information about a group of people, one or more person's nicknames, one or more person's identification numbers, one or more person's photos, one or more person's avatar images or may contain no information. According to some embodiments of the present invention, when two or more persons want to book a room and/or purchase other hotel services, the second row comprises two or more cells similar to cell 2421, as given below;
the cells 2422, 2424 and 2418 are elements for discussion between the hotel employee and potential customers. The cell 2422 contains the message from the person who wants to book a room and/or purchase one or more hotel services. The cell 2424 contains the reply message from the hotel employee. The message in the cell 2424 will not be visible to the person. The hotel employee can edit the message until he clicks on the button 2418. Upon doing this, the hotel computer system sends the message to the person's computer system, deletes all information from the text field 2424, adds the sent message to the discussion by creating the cell with the sent message and dashed border, places the newly created cell under the cell 2422 and moves the text field 2424, button 2418 and other cells down.
the cell 2430 contains information about the status of the chosen room. In this embodiment, the room hasn't been chosen, so the hotel computer system displays the notification about this fact in the cell 2430. In some embodiments of the present invention, the cell 2430 can contain a link, clicking on which will allow the user of the hotel computer system to choose the room for one or more persons who want to book one or more rooms and/or purchase other hotel goods and services.
   The third row comprises the following elements:
the cell 2425 contains the data “3,” which shows the number of the row.
the cell 2426 contains the data about the room type that was assigned to the person who sent the message 2429 to the hotel. In some embodiments, the user of the hotel computer system will have the ability to search for potential customers who are interested in hotel goods and/or services and send a message to one or more potential customers. The search (or scan) system can show the results of search in different ways, for example, in a table, on a map or in other ways. In some embodiments, the person will have the ability to indicate that he is interested in goods and/or services and wants other persons and/or companies to send him offers or promotional materials. In this case, the user of the hotel computer system will be able to see on the map and/or on the table the list of persons who are interested in the hotel goods and/or services or in other fields that are close to the hotel, for example, food, coffee, cab services.
the cell 2427 contains the room number that was assigned to the current prospective client whose information is shown in the cell 2428. The room number in cell 2427 is represented by underlined text, which is a link. The link, in this embodiment, can be used by the user of the hotel computer system to change the room for the particular person who wants to rent a room and whose identity is located in the cell 2428. In this particular embodiment, one type of room can be changed to one or more types of room. For example, room number one belongs to standard and presidental suite categories of room. Accordingly, in some embodiments of the present invention, a room can belong only to one type of the room. In some embodiments of the present inventions, one type of room can have one or more rooms;
the cell 2428 contains information about one or more persons, who are interested in the hotel services. In this exemplary embodiment, the cell 2428 contains information about one person named “Andrew Lyubachev;”
the cells 2429, 2417,2418 are elements which can be used for discussion between one or more hotel representatives and one or more potential customers. In this exemplary embodiment, the potential customer, named “Andrew Lyubachev” sent a message “Hi, I'm a very famous man and I need something special. Please surprise me.” to the hotel. This message is shown in the cell 2429.
the cell 2430 contains information about the status of the room. According to the exemplary embodiment, the room was chosen, but not booked yet.
   The fourth row comprises the following elements:
the cell 2431 contains information about the number of the row. In this exemplary embodiment, the cell 2431 contains the data “4,” which indicates that the cells 2431, 2432, 2433, 2436, 2437, 2438 belonged to the fourth cell. In some embodiments, the cell might contain one or combination of: time and/or date when the message was received by the hotel computer system, color indication, symbol indication, audio record, video record, user ID.
the cell 2432 contains information about the type of room that was assigned for the potential customer “Grigoriy Lyubachev, Kate Tsirkunova;”
the cell 2433 contains the text and text field 2434, which can be used by one or more hotel representatives to assign the specific room number for the potential customers “Grigoriy Lyubachev, Kate Tsirkunova.” In some embodiments, the room can be assigned by the potential customer. To submit the typed room number, the one or more hotel representatives need to click the submit button. However, in some embodiments, the room will be submitted (assigned) after the one or more hotel representatives click on the keyboard or change the focus to one or more other fields. In this exemplary embodiment, the submit button 2435 is shown only for purposes of explanation. At the moment of the creation of this specification, the current invention can be implemented without button 2435, submitting the room number in the background. However, the current invention will provide the same result with the button 2435;
the cell 2436 contains data about one or more potential customers. In this exemplary embodiment, the cell contains information about two people—Grigoriy Lyubachev and Kate Tsirkunova. In some embodiments, the cell can contain links to one or more potential customer profiles, which might contain, but is not limited to, one or more combination of the following information: last name, first name, sex, occupation, residence, current location, messages, updates, sound records, video records, photo and other graphical images, information about previous purchases, information about interaction with one or more software applications (including web and cloud based application, applications for smartphones, tablet PCs or virtual machines);
the cells 2437, 2417, 2418 are used for communication between the one or more hotel representatives and one or more potential customers. In this exemplary embodiment, Grigoriy Lyubachev or Kate Tsirkunova sent the message “Hi, Actually I don't need a room. I'm writing this message because I'm bored. Can you send me a funny story? Thanks.” to the hotel computer system. The one or more hotel computer system representatives didn't reply to this message from the cell 2437;
the cell 2438 contains information about the status of the room. In this exemplary embodiment, the cell 2438 indicates that the room hasn't been chosen since one or more users of the hotel computer system didn't click on the button 2435.
   It should be understood that the graphical user interface 2401, shown in FIG. 24A and FIG. 24B, is only one embodiment of the present invention.
   In some embodiments, especially if the promo-campaign will be reviewed by a large number of people, the present invention can be implemented by the system shown in FIG. 23. The system 2314 comprises the following elements:
the cloud 2303. In this exemplary embodiment, the cloud comprises one or more computer systems that can create a network, connect to an already created network, including one pm the Internet, send data to one or more computer systems, receive data from one or more computer systems, store data in the memory. Typically, the cloud 2303 is organized in special data centers as well as in the company or individual infrastructure;
the first account 2308. According to some embodiments of the present invention, there can be two types of accounts: user or corporate. The first account 2308 is a user account, which can be used by one or more users for authentication and by one or more companies to get one or more parts of the following information: interaction with one or more software programs, history of purchases, personal information, information about current geographical location, residence, previous interactions between one or more company representatives, time between the answers, time stamp of each action of the user, information about connections of the user (including friends, colleagues, acquaintances, etc.);
the portable multifunction device 2301, which can be used by one or more users to sign into one or more programs located in the cloud;
optionally, the system might comprise the group of devices 2310, which have one or more means for communication and one or more processors. A very wide range of electronic devices can be used for the purposes of the invention, for example, personal computer 2313, a laptop 2312, a smartphone 2311. It should be understood, however, that the present invention should not be limited to the above specific devices.
the second account 2309. The second account 2309 is a corporate account that can be used by the company to log into part or full cloud environment. The account 2309, in this exemplary embodiment, comprises one or more of the following elements: information about the company, statistics about promo-campaigns, information about interaction between one or more users with the user or corporate account types, financial information related to the promo-campaigns or advertisements, prizes or bonuses along with code, which can be used by the participants of the promo-campaign to redeem the prize or bonus, task management functionality, logistics functionality, information about shipment and/or delivery of the goods and/or services, goods and services availability, warehouse status, etc.
the computer system 2302, which can be used by one or more company representatives to perform one or more of the following tasks: create one or more promo-campaigns, delete one or more promo-campaigns, pause the activity of one or more promo-campaigns, start the activity of one or more promo-campaigns, get the statistics information from one or more promo-campaigns, assign a budget for one or more promo-campaigns, edit the budget of one or more promo-campaigns, record the activity of one or more users, track the interaction between one or more users with one or more programs. In some embodiments of the present invention, part or all of the above-mentioned functionality can be implemented in the form of API (Application Programming Interface).
Optionally, the system can comprise more than one computer system. The group of computer systems 2304 comprises one or combination of the following computer systems: a portable multifunction device 2305, a laptop or tablet PC 2306, a personal computer 2307, a virtual machine. It should be mentioned that the system 2314 can comprise one or more computer systems, as mentioned above that can use corporate account 2309.
   As shown in FIG. 23, all communications between computer systems that use a user account and computer systems that use a corporate account proceed through the cloud 2303. However, the present invention should not be limited to the system 2314. In some embodiments, the computer system 2314 has capabilities for communication between devices without using the cloud 2303. In some embodiments, the system 2314 can comprise one or more cloud environments. In some embodiments, the system 2314 can comprise one or more computer systems, which can use both types of accounts: user and corporate. In some embodiments, the system 2314 can comprise only one computer system, which will have access to both types of accounts and have functionality from the user type of account and the corporate type of account.

Disclaimer. The example companies, organizations, products, people, places and events depicted herein are fictitious. No association with any real company, organization, product, person, places, or events is intended or should be inferred.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer implemented method for goods and/or services promotion, comprising:
a. preliminarily creating a plurality of promo-campaigns, containing information about one or more goods and/or services;
b. distributing the one or more of the preliminarily created promo-campaigns to a first computer system;
c. sending one or more messages, associated with the promo-campaign, from the first computer system to the second computer system;
d. receiving, at the second computer system the one or more messages from the first computer system;
e. analyzing the received one or more messages contents;
f. if, after the analysis, the user of the second computer system reveals or the second computer system identifies, by means of implemented algorithm, that the user of the first computer system requested one or more goods and/or services, the second computer system, by means of the implemented algorithm, or the user of the second computer system performs the following steps:
i. assigning a newly generated or a preliminarily created identifier, which identifies the first computer system or the one or more user of the first computer system in the promo campaign or in the second computer system;
ii. sending the identifier, obtained on the previous step to the first computer system;
g. if, after the analysis, the user of the second computer system reveals or the second computer system identifies, by means of implemented algorithm, that the user of the first computer system requested additional details about promo-campaign, the user of the second computer system or the second computer system, by means of the implemented algorithm, performs the following steps:
i. creating one or more messages with information requested by the user of the first computer system-or assigning preliminarily created one or more messages, which comprises information about promo campaign terms and conditions or description;
ii. sending one or more messages, obtained on the previous step, to the first computer system.

2. The method of claim 1, wherein the created promo-campaign is distributed to one or more computer systems.

3. The method of claim 1 or 2, further comprising the step of additional editing of the preliminary created promo campaign just before the step b.

4. The method of any of the claims 1, 3, wherein the distribution of the promo campaign is done by establishing a network connection between the second and first computer systems, sending the promo campaign content from the second computer system to the first computer.

5. The method of any of the claims 1, 4, wherein the distribution of the promo campaign is done by:
i. establishing a network connection between the second and intermediate computer system;
ii. sending promo-campaign content to the intermediate computer system;
iii. establishing a network connection between the first and intermediate computer systems;
iv. sending a request from the first computer system to the intermediate computer system requesting one or more promo campaigns from the intermediate computer system;
v. getting the one or more promo campaigns from the intermediate computer system.

6. The method of any of the claims 1, 4, wherein before the distribution of the one or more promo campaigns, the second computer system receives a request from the first computer system for one or more goods and/or services.

7. The method of any of the claim 1 or 4, wherein the promo campaign comprises one or a combination of the following elements:
i. a text;
ii. a sound record;
iii. an advertisement;
iv. a video record;
v. a SMS;
vi. a MMS;
vii. a EMS;
viii. one or more images;
ix. one or more drawing elements;
x. one or more identifiers.

8. The method of any of the claim 1 or 4, wherein the message comprises one or a combination of the following elements:
i. a text;
ii. a sound record;
iii. an advertisement;
iv. a video record;
v. a SMS;
vi. a MMS;
vii. a EMS;
viii. one or more images;
ix. one or more drawing elements;
x. one or more identifiers.

9. The method of any of the claim 1 or 4, wherein the identifier comprises one or a combination of the following elements:
i. a text;
ii. a sound record;
iii. an advertisement;
iv. a video record;
v. a SMS;
vi. a MMS;
vii. a EMS;
viii. one or more images;
ix. one or more drawing elements;
x. one or more identifiers.

10. A computer implemented method for goods and services promotion, comprising:
a. preliminarily creating, by one or more users of a second computer system, a promo-campaign, which contains information about one or more goods and/or services;
b. distributing the created promo-campaign to at least two computer systems from the first computer system group, wherein the first computer system group comprises at least two computer systems;
c. creating a group of two or more computer systems by the first computer system from the first computer system group via sending one or more requests to join group to other users of the computer systems from the first computer system group;
d. sending one or more messages, associated with the promo-campaign, from at least one computer system from the group, created on the step c. and group identifier, that the one or more messages were sent from one or more computer systems from the group, created on the step c.;
e. receiving, at the second computer system, the one or more messages, sent on the previous step;
f. analyzing the received one or more messages content;
g. if, after the analysis, the user of the second computer system reveals or the second computer system identifies by means of implemented algorithm, that at least one user of the computer system from the first computer system group requested one or more goods and/or services, the second computer system by means of the implemented algorithm or the user of the second computer system performs the following steps:
1. generating a new identifier or assigning previously created identifier;
2. sending the identifier, obtained on the previous step to the computer system from the first computer system group, user of which requested one or more goods and/or services or to all computer systems from the first computer system group;
h. if, after the analysis, the user of the second computer system reveals or the second computer system, by means of implemented algorithm, identifies that at least one user of the computer system from the first computer system group requested additional information about promo-campaign description/contents, the user of the second computer system or the second computer system, by means of the implemented algorithm, performs the following steps:
1. creating, one or more messages with information requested by the user of the computer system from the first computer system group or assigning preliminarily created one or more messages, which comprises information about promo campaign terms and conditions or description;
2. sending one or more messages, obtained on the previous step, to the computer system from the first computer system group, user of which requested additional information.

11. The method of claim 10, further comprising the step of additional editing of the preliminary created promo campaign just before the step b.

12. The method of any of the claims 10, 11, wherein the distribution of the promo campaign is performed by establishing a network connection between the second and at least two computer systems from the first computer system group, sending the promo campaign content from the second computer system to the at least two computer systems from the first computer system group.

13. The method of any of the claims 10, 12, wherein the distribution of the promo campaign is performed by:
1. establishing a network connection between the second and intermediate computer system;
2. sending promo-campaign content to the intermediate computer system;
3. establishing a network connection between the one or more computer systems from the first computer system group and intermediate computer system;
4. sending a request from the one or more computer systems from the first computer system group to the intermediate computer system requesting one or more promo campaigns from the intermediate computer system;
5. getting, to the one or more computer systems from the first computer system group, the one or more promo campaigns from the intermediate computer system.

14. The method of any of the claims 10, 13, wherein the creating of the promo campaign begins after receiving one or more requests for one or more goods and/or services from the one or more computer systems from the first computer system group.

15. The method of any of the claims 10, 14, wherein the promo campaign comprises one or a combination of the following elements:
1. a text;
2. a sound record;
3. an advertisement;
4. a video record;
5. a SMS;
6. a MMS;
7. a EMS;
8. one or more images;
9. one or more drawing elements;
one or more identifiers.

16. The method of claim 10, wherein the message comprises one or a combination of the following elements:
1. a text;
2. a sound record;
3. an advertisement;
4. a video record;
5. a SMS;
6. a MMS;
7. a EMS;
8. one or more images;
9. one or more drawing elements;
10. one or more identifiers.

17. The method of claim 10, wherein the identifier comprises one or a combination of the following elements:
1. a text;
2. a sound record;
3. an advertisement;
4. a video record;
5. a SMS;
6. a MMS;
7. a EMS;
8. one or more images;
9. one or more drawing elements;
10. one or more identifiers.

18. The method of claim 10, wherein the one or more computer systems from the first computer group automatically joins the group, created by the user of the first computer system from the first computer system group.

19. The method of claim 10, wherein the one or more requests to join the group are automatically accepted.

20. The method of claim 10, wherein the group is forming automatically with the one or more computer systems, which are geographically located near the first computer system from the first computer system group.

21. The method of claim 10, wherein the group is forming automatically with the one or more computer systems, taking into account their participation in previously associated groups.

22. The method of claim 10, wherein the group is forming automatically using filters.

23. A computer implemented method for goods and/or services promotion, comprising:
a) sending, by the one or more users of the first computer system, one or more messages to the second computer system, notifying the one or more users of the second computer system, that the one or more users of the first computer system are interested in one or more goods and/or services
b) receiving, at the second computer system the one or more messages from the first computer system;
c) analyzing the received one or more messages contents;
d) if, after the analysis, the user of the second computer system reveals or the second computer system identifies, by means of implemented algorithm, that the user of the first computer system requested one or more goods and/or services, the second computer system, by means of the implemented algorithm, or the user of the second computer system performs the following steps:
1. assigning a newly generated or a preliminarily created identifier, which identifies the first computer system or the one or more user of the first computer system in the promo campaign;
2. sending the identifier, obtained on the previous step to the first computer system;
e) if, after the analysis, the user of the second computer system reveals or the second computer system identifies, by means of implemented algorithm, that the user of the first computer system requested additional details about promo-campaign, the user of the second computer system or the second computer system, by means of the implemented algorithm, performs the following steps:
1. creating one or more messages with information requested by the user of the first computer system-or assigning preliminarily created one or more messages, which comprises information about promo campaign terms and conditions or description;
2. sending one or more messages, obtained on the previous step, to the first computer system.

24. The method of claim 23, wherein the one or more messages are preliminary created; the one or more users of the first computer system choose the one or more preliminary created messages and send the one or more messages, which are chosen by the one or more users of the first computer system, to the second computer system.

25. The method of claim 24, wherein the one or more users of the first computer system choose and edit the one or more preliminary created messages before sending.

26. System for goods and services promotion, comprising:
a. a first computer system;
b. a second computer system;
wherein the second computer system comprises:
one or more processors #2;
one or more devices for storing data #2;
one or more communication modules #2;
one or more programs #2;
wherein the one or more programs #2 are stored in the one or more devices for storing data #2 and configured to be executed by the one or more processors #2, the one or more programs #2 containing instructions for:
creating a promo-campaign, which contains information about one or more goods and/or services;
distributing, by means of the one or more communication modules #2 the created promo-campaign to other one or more computer systems;
receiving, by means of the one or more communication modules #2, the one or more messages from other one or more computer systems;
analyzing the received one or more messages contents;
generating a new identifier or assigning previously created identifier to the particular one or more computer systems;
sending the identifier, by means of the one or more communication modules #2, to other one or more computer systems;
wherein the first computer system comprises:
one or more processors #1;
one or more devices for storing data #1;
one or more communication modules #1;
one or more programs #1;
wherein the one or more programs #1 are stored in the one or more devices for storing data #1 and configured to be executed by the one or more processors #1, the one or more programs #1 containing instructions for:
receiving the promo-campaign, by means of the one or more communication modules #1, from other one or more computer systems;
sending one or more messages, regarding promo campaign, by means of the one or more communication modules #1 to the one or more computer systems, associated with the promo campaign;
receiving the identifier, by means of the one or more communication modules #1, from other one or more computer systems.

27. The system of claim 26, wherein the first computer system additionally comprises a display device.

28. System for goods and services promotion, comprising:
a. a first computer system;
b. a second computer system;
wherein the second computer system comprises:
one or more processors #2;
one or more devices for storing data #2;
one or more communication modules #2;
one or more programs #2;
wherein the one or more programs #2 are stored in the one or more devices for storing data #2 and configured to be executed by the one or more processors #2, the one or more programs #2 containing instructions for:
creating a promo-campaign, which contains information about one or more goods and/or services;
distributing, by means of the one or more communication modules #2 the created promo-campaign to other one or more computer systems;
receiving, by means of the one or more communication modules #2, the one or more messages from other one or more computer systems;
analyzing the received one or more messages contents;
receiving the identifier, by means of the one or more communication modules #2, from the first computer system or intermediate computer system;
wherein the first computer system comprises:
one or more processors #1;
one or more devices for storing data #1;
one or more communication modules #1;
one or more programs #1;
wherein the one or more programs #1 are stored in the one or more devices for storing data #1 and configured to be executed by the one or more processors #1, the one or more programs #1 containing instructions for:
receiving the promo-campaign, by means of the one or more communication modules #1, from other one or more computer systems;
sending one or more messages, regarding promo campaign, by means of the one or more communication modules #1 to the one or more computer systems, associated with the promo campaign;
generating a new identifier or assigning previously created identifier to the first computer system.

29. The system of claim 28, wherein the one or more programs #1 comprises additional instructions for sending the identifier, created or generated on the first computer system, to the second computer system or intermediate computer system; wherein the one or more programs #2 comprises additional instructions for receiving the identifier, by means of the one or more communication modules #2, from the first computer system or intermediate computer system.
